(19) United States
(12) Patent Application Publication
(10) Pub. No.: US 2022/0335823 A1
(43) Pub. Date: Oct. 20, 2022

(54) PRODUCING VEHICLE DATA PRODUCTS FROM STREAMED VEHICLE DATA BASED ON DUAL CONSENTS

(71) Applicant: Wejo Limited, Manchester (GB)

(72) Inventor: Stuart Constantine, Liverpool (GB)

(21) Appl. No.: 17/722,336

(22) Filed: Apr. 16, 2022

Related U.S. Application Data
(60) Provisional application No. 63/176,172, filed on Apr. 16, 2021.

(51) Int. Cl. G08G 1/01; H04W 4/46

(52) U.S. Cl. CPC G08G 1/0141; G08G 1/0145; H04W 4/46

(57) ABSTRACT

A data product system and method for generating and providing a data product using data supplied by a multitude of vehicles. The data product system is configured to generate a first data product using first repository data that is based on a first data stream that is transmitted from the vehicles provided a first consent has been received; receive second consent data indicating that a vehicle user has provided the second consent; generate the second data product using second repository data that is received from the remote data repository and that includes, or is at least in part based on, one or more data items of the second data stream as stored in the remote data repository once the one or more data items begin to be received by the remote data repository; and provide the first and second data product to at least one third party computing device.

### TECHNICAL FIELD

This disclosure relates to methods and systems for streaming data from a very large number of vehicles to a remote data repository and generating data products based on the streaming data.

### BACKGROUND

Nowadays, there is a large amount of data streamed from automobiles and other vehicles, and this data is used for various purposes, such as for providing traffic conditions of roads. In many scenarios, vehicles are configured to transmit or stream the same data continuously or periodically to a remote location, such as a remote server. In some instances, the vehicle user or operator may be asked to consent to transmission of such data.

### SUMMARY

It has been discovered that it may be desirable to modify which data is being transmitted or streamed and/or to modify certain data streaming parameters, such as the frequency or rate with which the data is being transmitted/streamed. In at least some of such cases, it may be desirable to first obtain a vehicle user or operator's consent to the modified data stream before causing the vehicle to transmit the modified data stream.

According to one aspect of the disclosure, there is provided a data product system for generating and providing a data product using data supplied by a multitude of vehicles. Each vehicle has vehicle electronics including: a plurality of vehicle subsystems each providing data; and a communications subsystem having a wireless communications device and being connected within the vehicle electronics such that the data from the vehicle subsystems is accessible by the communications subsystem, wherein the communications subsystem is configured to: (i) transmit a first data stream having data accessed from the vehicle subsystems, wherein the first data stream is transmitted based on a first consent having been received; (ii) receive a streaming data change request, wherein the streaming data change request is sent in response to a determination that a second consent to transmit a second data stream has been received, wherein the second data stream is different from the first data stream in that the second data stream includes at least one data item not included in the first data stream, and wherein the second consent is received from a vehicle user through use of a mobile application; and (iii) in response to receiving the streaming data change request, transmit the second data stream to the remote data repository. The data product system is remote from the multitude of vehicles and includes one or more electronic processors and memory storing computer instructions and wherein the data product system is configured so that, when the computer instructions are executed by the one or more electronic processors, the data product system: (i) generates a first data product using first repository data that is received from the remote data repository and that includes, or is at least in part based on, at least one data item that is contained in the first data streams received from at least some of the multitude of vehicles; (ii) receives second consent data indicating that a vehicle user has provided the second consent; (iii) generates the second data product using second repository data that is received from the remote data repository and that includes, or is at least in part based on, one or more data items of the second data stream as stored in the remote data repository once the one or more data items begin to be received by the remote data repository; and (iv) provides the first data product to at least one third party computing device and provides the second data product to the same and/or another third party computing device.

According to various embodiments, the data product system may further include any one of the following features or any technically-feasible combination of some or all of the following features:
the data product system is configured so that, when the computer instructions are executed by the one or more electronic processors, the data product system: in response to receiving the second consent data, enrolls the vehicle into a data stream service in which the second data stream is provided from the vehicle to the remote data repository; and after enrolling the vehicle into the data stream service, causes a streaming data change request to be sent to the communications subsystem;
the streaming data change request indicates the one or more data items to be included in the second data stream;
the communications subsystem is configured to, in response to receiving the streaming data change request, configure the communications subsystem to obtain the one or more data items based on the data provided by the plurality of vehicle subsystems;
the mobile application is an in-vehicle application that is downloadable to and executable by the vehicle;
the communications subsystem is configured to, in response to receiving the second consent from the vehicle user via the in-vehicle application, transmit the second consent data to the data product system;
the mobile application is configured to be executed by a handheld mobile device; and/or
the first data stream is a data stream that is streamed from each of the multitude of vehicles as a result of a standard original equipment manufacturer (OEM) remote data streaming configuration; and/or the streaming data change request is transmitted from the data product system to an original equipment manufacturer (OEM) gateway and then from the OEM gateway to the communications subsystem.

According to another aspect of the disclosure, there is provided a method of generating and providing a data product using data supplied by a multitude of vehicles. The method includes: generating a first data product using first repository data that is received from a remote data repository and that includes, or is at least in part based on, at least one data item that is contained in a first data stream received from at least some of the multitude of vehicles; receiving second consent data indicating that a vehicle user has provided a second consent, wherein the multitude of vehicles are configured to transmit the second data stream to the remote data repository in response to receiving a streaming data change request, wherein the streaming data change request is sent in response to a determination that the second consent to transmit a second data stream has been received, wherein the second data stream is different from the first data stream in that the second data stream includes at least one data item not included in the first data stream, and wherein the second consent is received from a vehicle user through use of a mobile application; generating a second data product using second repository data that is received from the remote data repository and that includes, or is at least in part based on, one or more data items of a second data stream as stored in the remote data repository once the one or more data items begin to be received by the remote data repository; and providing the first data product to at least one third party computing device and providing the second data product to the same and/or another third party computing device.

According to various embodiments, the method may further include any one of the following features or any technically-feasible combination of some or all of the following features:
the method is carried out by a data product system that is remote from the multitude of vehicles and comprises one or more electronic processors and memory storing computer instructions, and wherein the data product system is configured so that, when the computer instructions are executed by the one or more electronic processors, the data product system carries out the method;
each of the multitude of vehicles is a vehicle having vehicle electronics including: a plurality of vehicle subsystems each providing data; and a communications subsystem having a wireless communications device and being connected within the vehicle electronics such that the data from the vehicle subsystems is accessible by the communications subsystem, wherein the communications subsystem is configured to: transmit the first data stream comprising data accessed from the vehicle subsystems, wherein the first data stream is only transmitted provided the first consent has been received; receive the streaming data change request; and in response to receiving the streaming data change request, transmit the second data stream to the remote data repository;
the data product system is configured so that, when the computer instructions are executed by the one or more electronic processors, the data product system: in response to receiving the second consent data, enrolls the vehicle into a data stream service in which the second data stream is provided from the vehicle to the remote data repository; and after enrolling the vehicle into the data stream service, causes a streaming data change request to be sent to the communications subsystem;
the streaming data change request indicates the one or more data items to be included in the second data stream;
the communications subsystem is configured to, in response to receiving the streaming data change request, configure the communications subsystem to obtain the one or more data items based on the data provided by the plurality of vehicle subsystems;
the mobile application is an in-vehicle application that is downloadable to and executable by the vehicle;
the communications subsystem is configured to, in response to receiving the second consent from the vehicle user via the in-vehicle application, transmit the second consent data to the data product system;
the mobile application is configured to be executed by a handheld mobile device;
the first data stream is a data stream that is streamed from each of the multitude of vehicles as a result of a standard original equipment manufacturer (OEM) remote data streaming configuration; and/or
the streaming data change request is transmitted from the data product system to an original equipment manufacturer (OEM) gateway and then from the OEM gateway to the communications subsystem.

### BRIEF DESCRIPTION OF THE DRAWINGS

Preferred exemplary embodiments will hereinafter be described in conjunction with the appended drawings, wherein like designations denote like elements, and wherein:

FIG. 1 depicts a communications system that includes a data product system and a plurality of vehicles, according to one embodiment;

FIG. 2 depicts a block diagram of vehicle electronics that may be included in each of the plurality of vehicles of FIG. 1, according to one embodiment;

FIG. 3 depicts a block diagram illustrating components of the communications system of FIG. 1, according to one embodiment;

FIG. 4 is a flowchart of a method of generating and providing a data product using data supplied by a multitude of vehicles, according to one embodiment;

FIG. 5 is a flowchart of a method of transmitting a data stream to a remote data repository in response to receiving consent to transmit the data stream, according to one embodiment;

FIG. 6 is a flowchart of a method generating and providing a data product using data supplied by a multitude of vehicles, according to one embodiment; and

FIG. 7 is a flowchart of a method of modifying a data stream and sending the data stream, as modified, to a remote data repository, according to one embodiment.

### DETAILED DESCRIPTION

The system and method described herein enables generation of a first and second data product that are based on a first and second data stream, respectively, which are received from a multitude of vehicles and where, for each of the multitude of vehicles, a first consent is received for transmitting the first data stream from the vehicle and a second consent is received for transmitting the second data stream from the vehicle—these two consents may collectively be referred to as dual consents. In some embodiments, the first consent may be provided to an original equipment manufacturer (OEM) of the vehicle, which may manage, configure, or otherwise enable the vehicle to provide the first data stream if the first consent has been received. And, in some embodiments, the second consent may be provided to a third party, such as a data product producer, that is independent of the OEM. The second consent may be received at a mobile application, which may be an in-vehicle application that is executed on the vehicle or a handheld mobile device application that is executed on a handheld mobile device, such as a smartphone.

The system and method are particularly useful for vehicles configured to capture various data as data items from a variety of mostly in-vehicle data sources, including, for example, image data from cameras, wheel speed data from wheel speed sensors, global navigation satellite system (GNSS) data from a GNSS receiver, other sensor data, as well as driver inputs and settings, etc. The connected vehicles are able to package and transmit at least some of this data to a remote data repository for storage. The collection of this data in real time from a multitude of vehicles (e.g., thousands or millions of vehicles) provides a great deal of information that can be used to create different data products such as real time traffic, weather conditions (e.g., based on windshield wiper operation), and diagnostic information organized by make and model for various vehicle manufacturers (OEMs). In some instances, it is desirable to modify a data stream provided by the vehicle or to initiate a new data stream provided by the vehicle. In some cases, this new stream, which is referred to herein as the second data stream, may include one or more data items that were not included as a part of the first data stream or consented to by the user as a result of the first consent, which may be provided by the user to the OEM at the time of purchase/lease of the vehicle, for example. Therefore, the system(s) and method(s) provided herein enable a second data stream to be transmitted from only those vehicles for which a user has provided the second consent to having the second data stream transmitted from the vehicle.

As used herein, the following terms have the definitions given. A “data item” is an individual piece of data of any data source type, having more than one possible value and that is implemented in any useful form, such as a number, character string, one or more bits (e.g., a flag/Boolean, a string or array of binary data or bytes), etc. A “data stream” is a continuous, periodic, or intermittent transmission of at least one data item for which the data values might vary between successive transmissions of the data item. A “data source” is a particular originator of data at any suitable level of abstraction, and examples of a data source include, for example, transducers and other sensors, processor-based modules and in-vehicle computer-readable memories, devices such as vehicles and portable connected devices (PCDs) (e.g., smartphones), data repositories, and facilities such as centralized servers. A “data source type” is a generic/subgeneric classification for data that may be included in a data stream from the vehicle based on the type of data source.

In one embodiment, data from a vehicle may be divided into two generic classifications: determined data and inputted data. Determined data is data originating from a vehicle subsystem, and inputted data is data originating from a vehicle occupant or an external source, such as a user or another vehicle. Determined data may include the subgeneric classifications of measured (or sensor) data, calculated data, lookup data, and metadata. Inputted data may include the subgeneric classifications of dynamic input data (e.g., driver inputs during a journey), configuration data (e.g., vehicle settings), and externally-source data (e.g., data from other vehicles, roadside equipment, a remote facility or server). The preceding two generic and seven subgeneric data source types are intended to encompass all possible data that can be provided in a data stream from a particular vehicle, but do not need to be considered mutually exclusive of each other. Examples of measured (or sensor) data includes speed, heading, acceleration, deceleration, and battery voltage. Examples of calculated data includes location as calculated by a GNSS receiver, seat occupancy, and battery state of charge. Examples of lookup data include diagnostic trouble codes (DTCs), calibration data, average battery voltage or state of charge, and other data obtained from a lookup table that is stored in memory. Examples of metadata include driver aggressiveness classification, transmission state, and battery system health. Examples of dynamic input data include windshield wiper activation/selection, stability control setting, accelerator and brake pedal inputs, steering inputs, radio volume, and headlight setting. Examples of configuration data include automatic rain sensing, touring/sport mode, max/min startup volume settings, and auto brightness headlights.

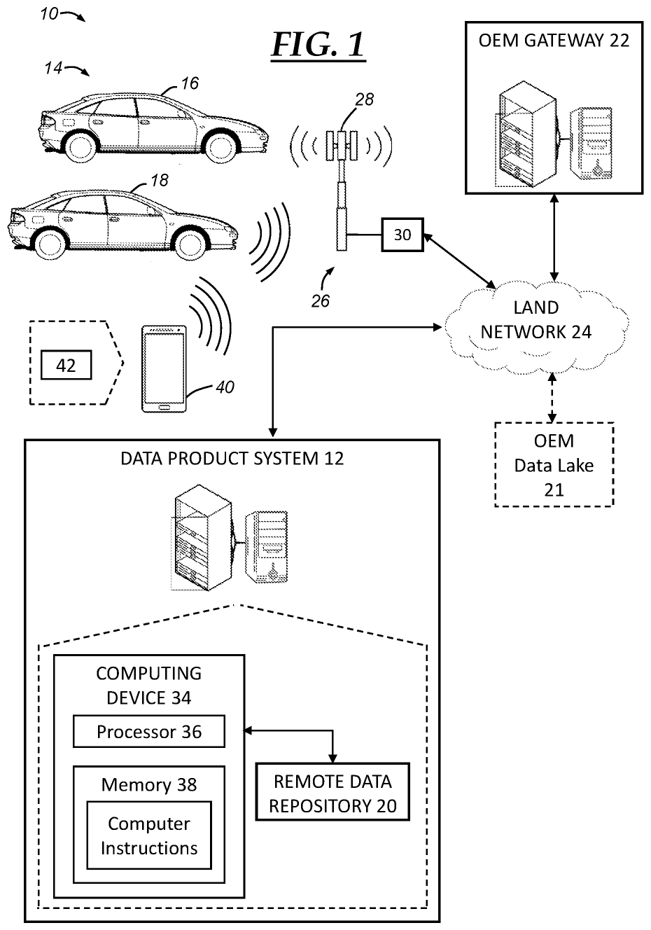

With reference now to FIG. 1, there is shown a communications system 10 that includes a data product system 12 having a remote data repository 20, a plurality of vehicles 14 including a first vehicle 16 and a second vehicle 18, an OEM lake 21, an OEM gateway 22, a land network 24, a wireless carrier system 26, and a handheld mobile device 40. Although only two vehicles are shown, it will be appreciated that the system is intended to be capable of working with a multitude of vehicles 14 (i.e., at least 1,000 vehicles) and even with millions of vehicles 14. Also, as used herein, the “vehicles” with which the data product system is used are connected vehicles (CVs) that are capable of wireless communication of data from the vehicle to a data lake or other remote data repository. It should be appreciated that while the illustrated embodiment of FIG. 1 provides an example of one such communications system 10, the data product system 12 and method(s) described below may be used as a part of various other communications systems.

The land network 24 may be a conventional land-based telecommunications network that is connected to one or more landline telephones and connects the wireless carrier system 26 to the data product system 12, the OEM data lake 21, and the OEM gateway 22. For example, the land network 24 may include a public switched telephone network (PSTN) such as that used to provide hardwired telephony, packet-switched data communications, and the Internet infrastructure. One or more segments of the land network 24 could be implemented through the use of a standard wired network, a fiber or other optical network, a cable network, power lines, other wireless networks such as wireless local area networks (WLANs), or networks providing broadband wireless access (BWA), or any combination thereof.

The wireless carrier system 26 may be any suitable cellular telephone system. The wireless carrier system 26 is shown as including a cellular tower 28; however, the wireless carrier system 26 may include additional cellular towers as well as one or more of the following components (e.g., depending on the cellular technology): base transceiver stations, mobile switching centers, base station controllers, evolved nodes (e.g., eNodeBs), mobility management entities (MMEs), serving and PGN gateways, etc., as well as any other networking components used to connect the wireless carrier system 26 with the land network 24 or to connect the wireless carrier system 26 with user equipment (UEs, e.g., which may include telematics equipment in the vehicles 14), all of which is indicated generally at 30. The wireless carrier system 26 may implement any suitable communications technology, including for example GSM/GPRS technology, CDMA or CDMA2000 technology, LTE technology, etc. In general, the wireless carrier system 26, its components, the arrangement of its components, the interaction between the components, etc. is generally known in the art.

The remote data repository 20 is used to store data received from the vehicles 14. For example, the vehicles 14 may each be configured to transmit a first data stream to the remote data repository 20 via the wireless carrier system 26 and the land network 24, and the remote data repository 20, upon receiving the first data stream, may store the data of the first data stream. The remote data repository 20 is shown as a part of the data product system 12, which may be owned and operated by an independent commercial partner of one or more of the vehicle original equipment manufacturers (OEMs). In other embodiments, the data repository may be any publicly or privately accessible aggregation of stored data, which can be structured or unstructured data and which is accessible over a global communications network such as the internet. For example, as optionally shown in FIG. 1, the OEM may have its own data lake (repository) 21 to which the data from the vehicle data streams are initially stored and then accessed (e.g., in real time) by the data product system to generate the first and second data products. However implemented, the remote data repository is remote in the sense that it is remote from the vehicles 14, but in some embodiments may be co-located with the data product system 12 (as shown) and/or with the OEM gateway 22. The remote data repository 20 may be, for example, one or more databases, data lakes, data warehouses, or some combination thereof.

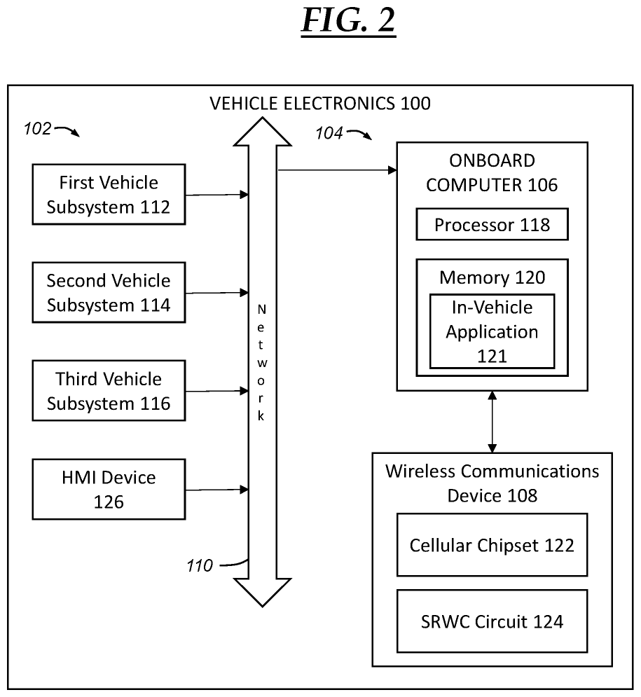

In some embodiments, the OEM may provide the data product system 12 with direct access to the vehicles; for example, by enabling direct streaming of the first and second data streams to the product system 12, rather than via the OEM gateway 22 (and optional OEM data lake 21). This may be done by providing the data product system the necessary credentials and access to the vehicles' communications system 104 (FIG. 2), and techniques for doing that will be known to those skilled in the art. Also, although the discussion herein oftentimes refers to transmitting the first data stream and the second data stream to the remote data repository 20, it should be appreciated that, in other embodiments, either or both of the first data stream and the second data stream may be transmitted to the OEM data lake 21 (or other OEM data repository) and accessed by the data product system 12.

The original equipment manufacturer (OEM) gateway 22 is a computer system that operates as an interface between the vehicles 14 and the data product system 12. The OEM gateway 22 may be operated, managed, owned, and/or controlled (collectively “managed”) by an OEM. The OEM gateway 22 may be implemented as computer instructions that are executed by one or more computers or computing devices. In one embodiment, the OEM gateway 22 is configured to receive streaming data change proposals from the data product system 12 and to determine whether to grant or forward those requests to one or more of the vehicles 14. For example, a streaming data change proposal may be received at the OEM gateway 22 from the data product system 12. In response, the OEM gateway 22 may determine whether to generate and/or send a streaming data change request to the subset of vehicles so as to cause the subset of vehicles to modify a data stream, such as for modifying the first data stream that is provided to the remote data repository 20. The OEM gateway 22 may implement certain rules or logic to determine whether a particular request from the data product system 12 should or should not be granted, such as whether the requested change would cause data used for other systems/applications to not be a part of the stream or whether the requested change would cause a reduction in performance to a level below a predetermined threshold amount or cause an increase in cost to an amount above a predetermine threshold amount.

The data product system 12 is a centralized or distributed computer system that is used to generate one or more data products having data from the remote data repository 20. In at least some embodiments, the data product system 12 is operated, managed, owned, and/or controlled by a data product party, which is a party that is separate than the OEM that manages the OEM gateway 22. The data product system 12 is shown as including a computing device 34 having an electronic processor 36 and computer-readable memory 38. As used herein an “electronic processor” is a physical processing device that operates under electrical power to execute computer instructions. These computer instructions are stored on the computer-readable memory 38, which is accessible by the electronic processor 36 so that the electronic processor 36 may execute the computer instructions stored on the memory 38. Although the data product system 12 is illustrated as including a single computing device 34, it should be appreciated that, in other embodiments, the data product system 12 includes a plurality of computing devices 34, each of which has an electronic processor and memory. Moreover, in at least some embodiments, the data product system 12 may be provisioned across numerous instances and the functionality described herein as being carried out by the data product system 12 may be carried out in a distributed fashion, such as by one or more computing devices that may or may not be co-located with one another. Additionally, it should be appreciated that the computer instructions of the data product system 12 may be stored on one or more memories and/or executed by one or more electronic processors, even though FIG. 1 depicts a single electronic processor and memory.

The handheld mobile device 40 is illustrated as a smartphone, but it should be appreciated that various other types of handheld mobile devices may be used as the handheld mobile device 40, such as a laptop, a tablet, an electronic wearable device, etc. The handheld mobile device 40 includes a wireless communications device, which may be or include either or both of a short-range wireless communications (SRWC) chipset and a cellular chipset. The handheld mobile device 40 further includes a human machine interface (HMI) device that is used to receive inputs from a user. In one embodiment, the HMI device of the handheld mobile device 40 may be a touchscreen, a pushbutton, or a microphone. In the case where the HMI device of the handheld mobile device 40 is a microphone, the microphone may be used to receive audio from the user and, through use of speech recognition techniques, determine an intent of the user. In some embodiments, the HMI device of the handheld mobile device 40 is both an HMI input device, which is an HMI device capable of receiving input from a user, and an HMI output device, which is an HMI device capable of providing output to a user. For example, the HMI device of the handheld mobile device 40 may be a touchscreen that provides a graphical user interface (GUI) and that is able to receive user inputs, such as by the user touching one or more portions of the GUI. In another embodiment, the handheld mobile device 40 includes an HMI input device that is used to receive input from a user and an HMI output device that is used to provide output to a user and that is separate from the HMI input device. In at least some embodiments, the HMI device of the handheld mobile device 40 is configured to receive input from the vehicle user indicating a consent, such as the second consent to transmit the second data stream, and this input or data derived therefrom may be provided to the communications subsystem 104 or the vehicle electronics 100, to the OEM gateway 22, and/or to the data product system 12, such as by way of the wireless carrier system 26 and/or the land network 24.

In some embodiments, the handheld mobile device 40 includes a handheld mobile device application 42, which is an example of a mobile application. The handheld mobile device application 42 may be downloadable to and executable by the handheld mobile device 40. The handheld mobile device application 42 may be comprised of handheld mobile device application computer instructions that, when executed by one or more electronic processors of the handheld mobile device 40, cause the handheld mobile device application 42 to receive input from a user indicating a consent, such as the second consent to transmit the second data stream. In one embodiment, the handheld mobile device application 42 may further be configured to display information pertaining to the second data stream, such as one or more data items that are included or to be included in the second data stream. The handheld mobile device application 42 may be downloaded from an application store (or app store), such as the iOS™ app store or Google™ Play, or another digital distribution platform. The handheld mobile device application 42 may provide the second consent data to the vehicle electronics 100 (FIG. 2) via Wi-Fi™, Bluetooth™, other SRWC technology, or other suitable connection. Moreover, the handheld mobile device application 42 may communicate with the data product system 12, and may provide the second consent data to the data product system 12 directly or without having to send the second consent data first to the vehicle electronics 100.

The plurality of vehicles 14 includes at least the first vehicle 16 and the second vehicle 18, each of which is depicted in the illustrated embodiment as a passenger car, but it should be appreciated that any other vehicle including motorcycles, trucks, sports utility vehicles (SUVs), recreational vehicles (RVs), other vehicles or mobility devices that can be used on a roadway or sidewalk, boats, other marine vessels, planes, unmanned aerial vehicles (UAVs), other aerial vehicles, etc., can also be used. Although FIG. 1 only depicts two vehicles 16, 18, it should be appreciated that the vehicles 14 may include any number of vehicles. In some embodiments, the data product system 12 is used to generate data products having data aggregated from information concerning a large number of vehicles and, in such embodiments, the communications system 10 may include a multitude of vehicles, which, as used herein, means at least one thousand (1,000) vehicles.

With reference to FIG. 2, there is shown vehicle electronics 100 that may be used as a part of the first vehicle 16 and/or the second vehicle 18. The vehicle electronics 100 are electronics that include one or more subsystems and/or components that are installed on a vehicle, such as the first vehicle 16 and the second vehicle 18. Although FIG. 2 depicts certain components and subsystems as being a part of the vehicle electronics 100, it should be appreciated that the vehicle electronics 100 may include various other components and/or subsystems in addition to or in lieu of those components and subsystems specifically shown in FIG. 2.

The vehicle electronics 100 includes a plurality of vehicle subsystems 102, a communications subsystem 104 having an onboard computer 106 and a wireless communications device 108, a communications network 110, and a human machine interface (HMI) device 126. The plurality of vehicle subsystems 102 is shown as including a first vehicle subsystem 112, a second vehicle subsystem 114, and a third vehicle subsystem 116; however, it should be appreciated that, in other embodiments, the plurality of vehicle subsystems 102 may include any suitable number of vehicle subsystems. In one embodiment, the first vehicle subsystem 112 is a vehicle positioning subsystem that is used to determine a global navigation satellite system (GNSS) position of the vehicle, such as a geographical positioning system (GPS) position that includes a latitudinal and longitudinal coordinate pair. The second vehicle subsystem 114, at least according to one embodiment, may be a body computer, and the third vehicle subsystem 116 may be an engine controller. Of course, any vehicle subsystem that provides data over the vehicle's bus (e.g., over communications network 110) or that otherwise provides data accessible by the communications subsystem 104 may be used as a data source for data items sent to the remote data repository.

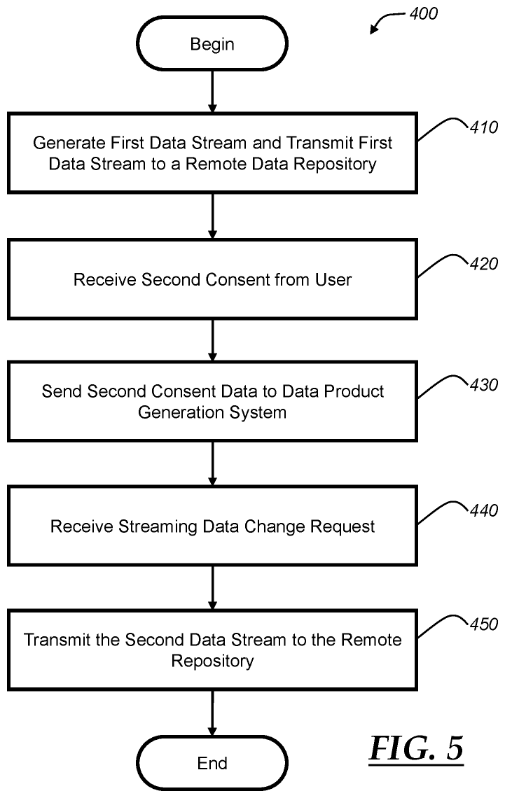

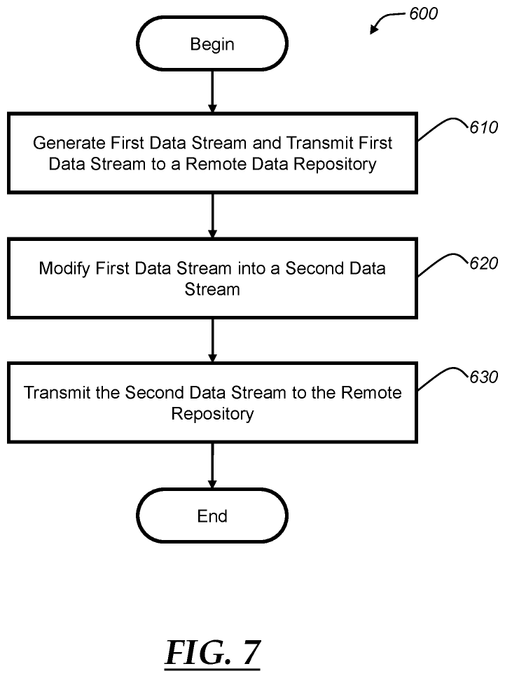

The communications subsystem 104 includes the wireless communications device 108 and is connected within the vehicle electronics 100 such that the data from the vehicle subsystems 102 is accessible by the communications subsystem 104. The communications subsystem 104 is also shown as including the onboard computer 106, which may be used to carry out various processing of the communications subsystem 104, such as that which is described below as being a part of method 400 (FIG. 5) and/or method 600 (FIG. 7). It should be appreciated that, although various processing of the communications subsystem 104 and/or the vehicle electronics 100 is described as being carried out by the onboard computer 106, in one or more embodiments, the processing described herein as being attributed to the onboard computer 106 may be carried out by one or more other computers of the vehicle electronics 100, including those that may or may not be considered as forming a part of the communications subsystem 104. Moreover, although the onboard computer 106 is shown and described as being separate from the wireless communications device 108, in one embodiment, the onboard computer 106 and the wireless communications device 108 are integrated into a single device or module. Also, although the onboard computer 106 and the wireless communications device 108 are illustrated as being directly coupled to one another, in other embodiments, the onboard computer 106 and the wireless communications device 108 may be coupled to each other via the communications network 110 or other suitable electronic communication connection.

The onboard computer 106 includes an electronic processor 118 and memory 120 having in-vehicle computer instructions. The memory 120 is operatively coupled to the electronic processor 118 so that the electronic processor 118 may access contents of the memory 120, including the in-vehicle computer instructions. The electronic processor 118 is configured to execute the in-vehicle computer instructions, which, in at least one embodiment, cause the method 400 (FIG. 5) to be carried out and/or cause the method 600 (FIG. 7) to be carried out.

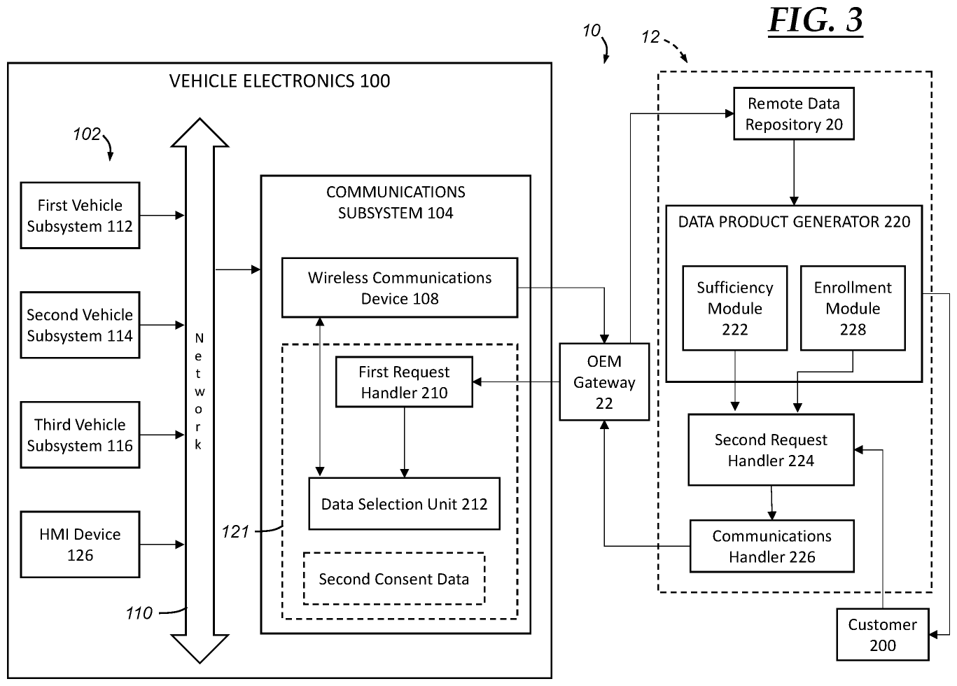

The memory 120 may also store an in-vehicle application 121, which is an example of a mobile application, and that may be used as to receive the second consent from a user. The in-vehicle application 121 may be comprised of in-vehicle application computer instructions that, when executed by one or more electronic processors of the vehicle electronics, cause the vehicle electronics to receive input from a vehicle user indicating a consent, such as the second consent to transmit the second data stream. As shown in FIG. 3, the second consent data may be stored in memory by the in-vehicle application 121 and used as a part of the in-vehicle application 121. In one embodiment, the in-vehicle application 121 may further be configured to display information pertaining to the second data stream, such as one or more data items that are included or to be included in the second data stream. The in-vehicle application 121 is downloadable to and executable by the vehicle electronics and, in at least some embodiments, may be downloaded to the vehicle electronics through an application store (or app store) hosted or managed by the OEM of the vehicle. In other embodiments, other digital distribution platforms may be used to provide the in-vehicle application 121 to the vehicle. In one embodiment, the in-vehicle application 121 is a product managed by the data product party, which also manages the data product system 12. In one embodiment, the in-vehicle application 121 may be used to send data from the vehicle to a remote data repository, such as the remote data repository 20, without having to send the data through an OEM computer system, such as the OEM gateway 22.

In some embodiments, the in-vehicle application 121 may be granted certain permissions that may be managed by the OEM, for example, and that may be implemented or enforced by one or more computing devices of the vehicle electronics, such as the onboard computer 106. In some embodiments, the permissions may specify or delineate read, write, or other types of access granted to the in-vehicle application 121. In some embodiments, the vehicle electronics 100 may grant the in-vehicle application 121 access to certain data and/or the capability of causing certain data to be transmitted to a remote device, such as the remote data repository 20. In some embodiments, one or more of the permissions, such as the permission to obtain or stream data, may only be permitted for the in-vehicle application 121 when the vehicle electronics 100 determines that the second consent has been received.

The wireless communications device 108 is used to provide remote network connectivity to the vehicle electronics 100. The wireless communications device 108 is illustrated as including a cellular chipset 122 and a short range wireless communication (SRWC) circuit 124. However, in other embodiments, the wireless communications device 108 may include only one of a cellular chipset 122 and a SRWC circuit 124. Long-range or remote data communications may be carried out by the wireless communications device 108, such as for purposes of transmitting streaming data to the remote data repository 20. The cellular chipset 122 may be used to provide internet connectivity to the vehicle electronics 100 through establishing communications with the cellular tower 28 of the wireless carrier system 26.

The SRWC circuit 124 enables the vehicle to send and receive wireless messages using one or more SRWC technologies, such as Wi-Fi™, Bluetooth™, IEEE 802.11p, other vehicle to infrastructure (V2I) communications, vehicle to vehicle (V2V) communications, other vehicle to everything (V2X) communications, etc. In one embodiment, the SRWC circuit 124 may be used to connect to a wireless access point hosted by another device, such as a wireless communication device included as a part of roadside equipment or a wireless router located at a vehicle user's residence, which may then provide internet or remote network connectivity. For example, the SRWC circuit 124 may transmit data from the vehicle to the remote data repository via a Wi-Fi™ connection between the wireless communications device 108 and a wireless router/modem, which is then connected to the internet, such as by way of land network 24.

The communications network 110 is an in-vehicle communications network that communicatively couples two or more components or subsystems of the vehicle electronics 100 to each other so that the two or more components may carry out communications. In the illustrated embodiment of FIG. 2, the communications network 110 is shown as communicatively coupling each of the plurality of subsystems 102 to the communications subsystem 104 and, specifically, the onboard computer 106. In one embodiment, the communications network 110 is implemented as one or more hardwired communication network busses, such as those used for providing a controller area network (CAN), a media oriented system transfer (MOST), a local interconnection network (LIN), a local area network (LAN), and/or other appropriate networks, such as those that use Ethernet or others that conform with known ISO, SAE and IEEE standards and specifications, to name but a few. In one embodiment, the communications network 110 may be implemented as a wireless LAN that uses Wi-Fi™, other IEEE 802.11 technology, or other suitable wireless networking technology.

In one embodiment, the onboard computer 106 is configured to obtain certain data communicated over the communications network 110 and, in a particular embodiment, to obtain certain data provided over one or more hardwired communication network busses. The onboard computer 106 may be initially configured to obtain data items that are used to form the first data stream that is transmitted from the vehicle electronics 100 to the remote data repository 20 using the wireless communications device 108. The vehicle electronics 100 (e.g., onboard computer 106) may be configured to transmit the first data stream subsequent to receipt of a first consent (to transmit such data). For example, the first data stream may be transmitted based on a determination that the first consent has been received, in which case the transmission of the first data stream occurs only if the first consent has been received. The storage of first (and/or second) consents, and the determination of receipt of a consent, can be at the vehicle and/or at a remote facility, As will be described in more detail below, each of the vehicles 14 may obtain data that is then streamed to the remote data repository 20 as a data stream.

In one embodiment, the onboard computer 106 stores one or more data models that are used to indicate one or more data items that are to be included in a data stream. In some embodiments, any one or more of the data models may also include information indicating data streaming parameters, such as the frequency with which the data items are to be captured and/or streamed. The data model(s) may be stored in the memory 120 and accessed by the electronic processor 118, such as during execution of the in-vehicle computer instructions. The “first data model” refers to a data model that is used to specify the data items that are included as a part of the first data stream, and the “second data model” refers to a data model that is not the first data model and that is used to specify the data items that are included as a part of the second data stream. In at least some embodiments, the first data model is specified as a part of an initial configuration or provisioning process of the vehicle electronics 100, such as at the time of manufacture of the vehicle or initial sale/lease of the vehicle. In such embodiments, the first data model may be referred to as an initial data model and the first data stream may be referred to as an initial data stream. Moreover, in some embodiments, the first data model is specified by an OEM of the vehicle as a result of its own volition (i.e., not as a result of a request by a third party) and, in such an embodiment, the first data model may be referred to as an OEM-provisioned data model and the first data stream may be referred to as an OEM-provisioned data stream.

The human machine interface (HMI) device 126 is provided as a part of the vehicle electronics and is used to receive inputs from a vehicle user. In one embodiment, the HMI device 126 is a touchscreen that may be provided, for example, as a part of an infotainment unit. In another embodiment, the HMI device 126 is a pushbutton that is located within a cabin of the vehicle. In yet another embodiment, the HMI device 126 is a microphone that is used to receive audio from the vehicle user and, through use of speech recognition techniques, determine an intent of the vehicle user. In some embodiments, the HMI device 126 is both an HMI input device and an HMI output device. For example, the HMI device 126 may be a touchscreen that provides a graphical user interface (GUI) and that is able to receive user inputs, such as by the vehicle user touching one or more portions of the GUI. In another embodiment, the vehicle electronics 100 include an HMI input device that is used to receive input from a user and an HMI output device that is used to provide output to a user and that is separate from the HMI input device. In at least some embodiments, the HMI device 126 is configured to receive input from the vehicle user indicating a consent, such as the second consent to transmit the second data stream, and this input or data derived therefrom may be provided to the communications subsystem 104. The communications subsystem 104 may be configured to then transmit this input or data derived therefrom to the OEM gateway 22 and/or to the data product system 12, such as by way of the wireless carrier system 26 and/or the land network 24.

Any one or more of the electronic processors discussed herein may be implemented as any suitable electronic hardware that is capable of processing computer instructions and may be selected based on the application in which it is to be used. Examples of types of electronic processors that may be used include central processing units (CPUs), graphics processing units (GPUs), field-programmable gate arrays (FPGAs), application specific integrated circuits (ASICs), microprocessors, microcontrollers, etc. Any one or more of the non-transitory, computer-readable memory discussed herein may be implemented as any suitable type of memory that is capable of storing data or information in a non-volatile manner and in an electronic form so that the stored data or information is consumable by the electronic processor. The memory may be any a variety of different electronic memory types and may be selected based on the application in which it is to be used. Examples of types of memory that may be used include including magnetic or optical disc drives, ROM (read-only memory), solid-state drives (SSDs) (including other solid-state storage such as solid-state hybrid drives (SSHDs)), other types of flash memory, hard disk drives (HDDs), non-volatile random access memory (NVRAM), etc. It should be appreciated that the computers or computing devices may include other memory, such as volatile RAM that is used by the electronic processor, and/or may include multiple electronic processors.

With reference to FIG. 3, there is shown the communications system 10, including the data product system 12, the vehicle electronics 100, the remote data repository 20, the OEM gateway 22, and a data product customer 200. As mentioned above, the vehicle electronics 100 may be used for each, or any suitable subset of, the vehicles 14. The vehicle electronics 100 are shown as including the plurality of subsystems 102 and the communications subsystem 104. The communications subsystem 104 includes the wireless communications device 108, a first request handler 210, and a data selection unit 212.

The first request handler 210 is a part of the communications subsystem 104 and is used to handle requests received from the OEM gateway 22 and, in particular, to handle streaming data change requests received at the vehicle electronics 100. Although FIG. 3 shows a communicative connection between the OEM gateway 22 and the first request handler 210, it should be appreciated that the streaming data change requests may be received at the first request handler 210 via the wireless communications device 108. In at least one embodiment, the first request handler 210 is configured to, in response to receiving a streaming data change request, process the streaming data change request, which may include approving or denying the streaming data change request. In other embodiments, the communications subsystem 104 may treat the streaming data change request, when received at the first request handler 210 from the OEM gateway 22, as a command that commands the vehicle to modify a data stream.

The data selection unit 212 is a part of the communications subsystem 104 and is used to select which data items are to be included as a part of a data stream that is streamed from the vehicle electronics 100 to the remote data repository 20. In some embodiments, the data selection unit 212 is a part of the in-vehicle application 121; however, in other embodiments, the data selection unit 212 is separate from the in-vehicle application 121. The data selection unit 212 is configured to, in response to a streaming data change request being received (and/or approved) at the vehicle electronics 100, modify a data stream, such as modifying the first data stream to exclude identified surplus data and to include one or more other data items that are not contained in the first data stream. In one embodiment, the data selection unit 212 is used to select a data model that is to be used to indicate which data items are to be included in the modified or second data stream.

Each of the first request handler 210 and the data selection unit 212 may be implemented as executable computer instructions that, when executed by one or more electronic processors of the communications subsystem 104 (e.g., the electronic processor 118 of the onboard computer 106), cause the communications subsystem 104 to carry out the functionality described herein as being attributed to the first request handler 210 or the data selection 212, respectively. Specifically, for example, the vehicle electronics 100 may include first request handler computer instructions that, when executed, cause the functionality attributed to the first request handler 210 to be carried out. In some embodiments, the first request handler 210 is a part of the in-vehicle application 121; however, in other embodiments, the first request handler 210 is separate from the in-vehicle application 121.

As is also shown in FIG. 3, the data product system 12 includes a data product generator 220 having a sufficiency module 222 and an enrollment module 228, a second request handler 224, and a communications handler 226. The data product generator 220 is used to transform data obtained from the remote data repository 20 into one or more data products, which may then be provided to the data product customer 200. As used herein, a “data product” is data derived or otherwise obtained from a collection of data items streamed as a part of one or more data streams that are transmitted from a group of vehicles to a remote data repository. In some embodiments the data product is containerized or packaged data according to a custom or standardized format or protocol. In one embodiment, various processing may be performed on the data for purposes of obtaining data to be included as a part of the data product. For example, the data product generator 220 may obtain data stored in the remote data repository 20 and perform various processing, such as analytics, on this obtained data so as to generate processed data that is then packaged into a data product. In other embodiments, the data product generator 220 may receive processed data from another device, module, or system that obtains and processes data stored in the remote data repository 20. And, in some embodiments, the data product generator 220 may receive processed data and also carry out further processing on this processed data, the result of which may then be included in the data product.

The data product generator 220 is shown as including the sufficiency module 222, which is used to identify surplus data. The surplus data may comprise one or more data items contained in the first data stream for which the first data product can be generated using the first data stream from a first subset of the plurality of vehicles—that is, the surplus data includes data item(s) that are a part of the first data stream, but that do not need to be received from each of the vehicles providing the first data stream because, for example, obtaining and storing these data item(s) is unnecessary or superfluous. For example, when there are 10,000 vehicles in a particular geographical region that are each sending traffic-related information as a part of the first data stream, it may be determined that the traffic-related information need not be received from each of the 10,000 vehicles, but that the traffic-related information should be received from only 2,000 of the 10,000 vehicles since such information from 2,000 vehicles is sufficient and such information from the other 8,000 vehicles is not needed or redundant. In such an instance, the first subset of vehicles corresponds to the 2,000 vehicles and the remaining 8,000 vehicles corresponds to a different subset of vehicles. In this example, the surplus data includes those data items that provide the traffic-related information. The sufficiency module 222 is shown in FIG. 3 as being a part or portion of the data product generator 220; however, it should be appreciated that the sufficiency module 222 may be implemented as a separate and distinct module that is communicatively coupled to the remote data repository 20, the data product generator 220, and/or another device or system that provides information to the sufficiency module regarding the data stored in the remote data repository 20 that is suitable for use in identifying the surplus data.

The surplus data may comprise specific data items from the first data stream that are not needed at the moment for any data product, or possibly not currently needed for any purpose at all, and can be excluded from the second (modified) data streams coming from the second subset of vehicles. Alternatively or additionally, the surplus data may comprise data supplied in the first data stream at a frequency in excess of that needed to produce the first data product, such that the streaming data change request may specify a longer period between occurrences of the data item in the stream, thereby lowering the total data transmission volume such that the additional data items needed for the second data product may be included with minimal or no increase to the total volume of data transmitted. In this way the data product system achieves increased efficiency in operation—by enabling it to generate additional data products without a concomitant increase in the total data volume transmitted from the vehicles individually and as a group.

In a like manner, the additional data needed for the second data product may comprise particular data items not contained at all in the first data stream, and/or may comprise existing data items in the first data stream for which a higher frequency of updates are needed. As examples, in the event of adverse weather that might affect drivability of roads in a particular geographic region (e.g., snow/sleet/ice accumulation from a storm), data not normally transmitted in the first data stream might be needed or desired to generate a (second) data product that provides more accurate/targeted information concerning driving conditions. This may include data items not normally sent concerning operator inputs such as windshield wiper activation, window defrost activation, climate control (e.g., max defrost fan) settings, selected vehicle gear/transmission settings. Alternatively or additionally, this may include data items that are included in the first data stream, but at a rate that is less than desired or needed for the second data product, such as transmission system data (e.g., wheel slip) or lateral accelerations (e.g., indicative of sliding). Some or all of this additional data may be identified in the data stream change request so that they are included in the second (modified) data stream in place of at least some of the surplus data that was being sent in the original (first) data stream.

In one embodiment, in addition to identifying the surplus data, the sufficiency module 222, or other portion of the data product system 12, may determine vehicle selection data that specifies a subset of vehicles. The vehicle selection data may include vehicle selection parameters or vehicle identification data. The vehicle selection parameters are parameters used to specify a subset of vehicles without uniquely identifying any of the vehicles in the subset of vehicles, and the vehicle identification data is data or information uniquely specifying each vehicle of a subset of vehicles. Examples of vehicle selection parameters include make, model, and geographic region. In one instance and according to one embodiment, it may be determined that traffic-related information, such as the vehicle location over time, may not be needed for a set of vehicles of a particular geographical region because that geographical region includes a very dense distribution of vehicles, such as may be the case in a heavily populated urban center. In such an instance, the data product system 12 may select one or more vehicles that are to forgo sending the traffic-related information as a part of the first data stream and the identity of these particular vehicles may be represented by vehicle selection data that is generated by the data product system 12. In another embodiment, the data product system 12 may identify vehicle selection parameters that are then included as a part of the vehicle selection data and, in one embodiment, these vehicle selection parameters may be included in lieu of (or in addition to) the vehicle identification data. In such embodiments, the OEM gateway 22 (or other system) may identify one or more particular vehicles based on the vehicle selection parameters received from the data product system 12.

The enrollment module 228, which is shown in FIG. 3 as being a part of the data product generator 220, is used to enroll vehicles into a data stream service, such as a data stream service in which the vehicle provides the one or more data items of the second data stream to a remote data repository. The second consent data, which indicates that a second consent to transmit the second data stream has been received, may be sent to the enrollment module 228 from the mobile application, which may be implemented as the in-vehicle application 121 or the handheld mobile device application 42. In one embodiment, the in-vehicle application 121 receives the second consent from the vehicle user via the HMI device 126. The vehicle electronics 100, such as through use of the communications subsystem 104, may then transmit the second consent data to the enrollment module 228. In one embodiment, the second consent data may be transmitted from the mobile application to the enrollment module 228 via the OEM gateway 22. In such an embodiment, the OEM gateway 22 may process one or more messages that include the second consent data and that are sent from the mobile application to the OEM gateway 22. Also, in such an embodiment, the OEM gateway 22, after having processed the one or more messages, may then transmit the second consent data to the enrollment module 228. In another embodiment, the mobile application may transmit the second consent data to the enrollment module 228 without sending or having to send the second consent data to the OEM gateway 22.

In at least one embodiment, the enrollment module 228 may be configured to, in response to receiving the second consent data, enroll the vehicle into a data stream service in which the second data stream is provided from the vehicle to the remote data repository; and after enrolling the vehicle into the data stream service, cause a streaming data change request to be sent to the communications subsystem that indicates that the second consent to transmit the second data stream has been received or that otherwise causes the vehicle to transmit the second data stream. The enrollment module 228 is shown in FIG. 3 as being a part or portion of the data product generator 220; however, it should be appreciated that the enrollment module 228 may be implemented as a separate and distinct module that is communicatively coupled to the remote data repository 20, the data product generator 220, and/or another device or system that provides the second consent data to the enrollment module 228.

The second request handler 224 is a part of the data product system 12 and is communicatively coupled to the sufficiency module 222 and the enrollment module 228. The second request handler 224 is responsive to identification of the surplus data and to data product request data. In some embodiments, the second request handler 224 is responsive to which data stream services one or more vehicles are enrolled in and/or otherwise responsive to the second consent data. In one embodiment, the second request handler 224 receives data identifying the data items of the surplus data and the vehicle selection data from the sufficiency module 222. The data product request data may be data indicating one or more data items that are to be included in a data product that is requested by the data product customer 200, such as the second data product. The data product request data may be provided to the second request handler 224 directly from the data product customer 200, such as through an application programming interface (API), or may be provided from the data product customer 200 to a person of the third party managing the data product system 12. In the latter case, the person may input the data product request data into the data product system 12 such that it is accessible by the second request handler 224. In one embodiment, the second request handler 224 is configured to receive an indication from the enrollment module 228 indicating that the second consent data has been stored or received, or otherwise indicating that the second consent has been received, such as by informing the first request handler 224 of the data stream services that the vehicle is enrolled in. In response, the first request handler 224 may generate one or more messages that are then sent by the communications handler 226, which cause the streaming data change request to be sent to the communications subsystem 104 of the vehicle electronics 100.

The communications handler 226 is used to initiate a streaming data change request to the second subset of vehicles, where the streaming data change request specifies one or more data items needed to generate the second data product. In at least some embodiments, the streaming data change request further specifies the surplus data or the data items of the first data stream that are no longer needed to be transmitted from the second subset of vehicles. The communications handler 226 may initiate the streaming data change request directly by sending the streaming data change request to the second subset of vehicles, or may initiate the streaming data change request by sending a streaming data change proposal to the OEM gateway 22, which then, based on the streaming data change proposal, sends the streaming data change request to the second subset of vehicles. The streaming data change request or the streaming data change proposal may be compiled by the communications handler 226 into one or more electronic messages, which are then sent to the OEM gateway 22 or the second subset of vehicles.

Each of the data product generator 220, the sufficiency module 22, the second request handler 224, the communications handler 226, and the enrollment module 228 may be implemented as executable computer instructions that, when executed by one or more electronic processors of the data product system 12 (e.g., the electronic processor 36 of the computing device 34), cause the data product system 12 to carry out the functionality described herein as being attributed to the data product generator 220, the sufficiency module 22, the second request handler 224, the communications handler 226, and the enrollment module 228, respectively. Specifically, for example, the data product system 12 may include data product generator computer instructions that, when executed, cause the functionality attributed to the data product generator 220 to be carried out.

In one example, the first data product is responsive to a generalized set of vehicle data in the first data stream and supports a first data product, such as generalized traffic intelligence information about vehicle road speeds, road densities, parking densities, travel times between major points, etc. The data product system 12 may, in response to an external weather forecast data, provide a request for enhanced environmental sensor information from a subset of vehicles in a designated geographical area. The second request handler 224 arbitrates this request by considering whether the designated geographical area has sufficient density of connected vehicles to send a request through the communications handler 226 to reassign a subset of the vehicles in the designated geographical area to send the enhanced environmental sensor data in lieu of at least some of the first data stream. Alternatively, the arbitration by the second request handler 224 may attach a relative weight to consider the importance or priority of the request. The OEM gateway 22 sends the responsive communications to the appropriate vehicle subset of connected vehicles 14. In an example, the data for the second data stream is already available on a vehicle data bus and accessible by the communications subsystem 104. The data selection unit 212 executes instructions directing the communications subsystem 104 to read the enhanced environmental sensor data from the vehicle data bus for transmission as the second data stream, which is sent using the wireless communications device 108. In an example, the enhanced environmental data may be processed, interpreted, normalized, or subject to other operations the results of which are included in the transmission of the second data stream along with or in lieu of the raw vehicle data bus data. Through the process described above, subset of the connected vehicles in the designated geographic area begin to transmit a second data stream that traverses communications channels as described above to the data product system 12, which uses the data to provide a weather-based data product.

In another example, the data product system 12 may request data in response to an external request from a supplier of modules that were installed by one or more vehicle original equipment manufacturers into at least a portion of the vehicles 14. This request may be for output, performance, or diagnostic data produced by or related to the modules from the supplier. This request may come from an external interface into system 12 or may come from a data product module within the data product system 12 responsive to a prior data product purchase arrangement between the operator of the data product system 12 and the supplier. As described above, the second request handler 224 arbitrates this request, including selecting a vehicle set or a vehicle criteria that can provide the data meeting the request, and sends the required communications through the communications handler 226. The OEM gateway 22 sends the responsive communications to the appropriate subset of vehicles 14. In this example a subset of the vehicles begin to transmit the second data stream that contains the module output, performance, and/or diagnostic data. This data stream traverses communications channels as described above to the data product system 12, which uses the data to provide a module performance data product to the supplier. The supplier may utilize this data for a variety of purposes, including, for example, to determine the performance of the module, determine whether a group of modules could benefit from a software update, or to support a service associated with the module. An advantage of this example is the potential for suppliers of vehicle components to request information about components already in production, which can be satisfied through data products added to the data product system 12.

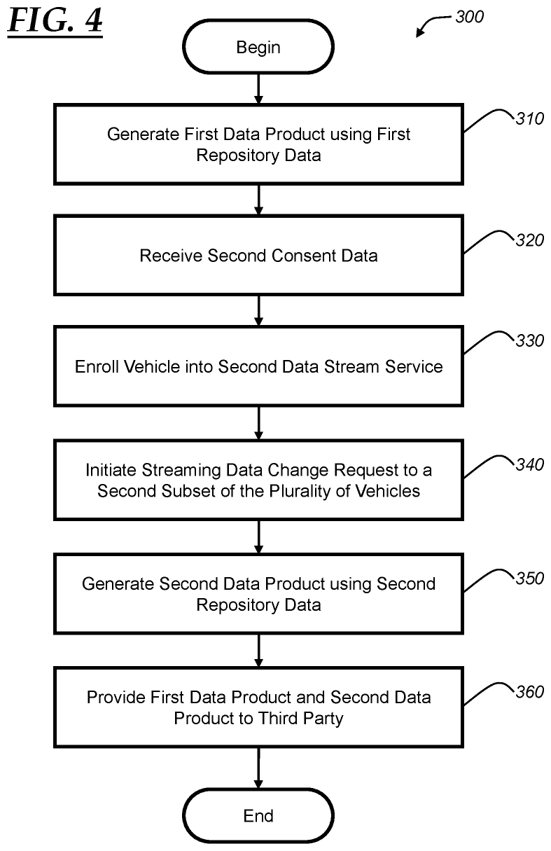

With reference to FIG. 4, there is shown an embodiment of a method 300 of generating and providing a data product using data supplied by a multitude of vehicles. According to at least some embodiments, the method 300 is carried out by the data product system 12 and, in particular, the data product system 12 includes one or more electronic processors (including the electronic processor 36) that are configured to execute computer instructions that, when executed by the one or more electronic processors, cause the data product system 12 to carry out the method 300. Although the steps of the method 300 are described as being carried out in a particular order, it should be appreciated that the steps of the method 300 may be carried out in any technically-feasible order.

The method 300 begins with step 310, wherein a first data product is generated using first repository data that is received from the remote data repository. The first repository data includes, or is at least in part based on, one or more data items that are contained in the first data streams received from at least some of the multitude of vehicles. In one embodiment, the data product generator 220 obtains data that was stored at the remote data repository 20 as a result of the first data stream from the multitude of vehicles and then processes the obtained data to generate the first data product. In another embodiment, the data that was stored at the remote data repository 20 as a result of the first data stream may first be processed, such as for calculating analytics describing the data, by another device or system before it is received at the data product generator 220. The method 300 continues to step 320.

In step 320, second consent data is received. The second consent data indicates that a second consent to transmit a second data stream has been received. In at least some embodiments, the second consent data is received at the enrollment module 228 of the data product system 12. The second consent data may originate at a mobile application in response to the mobile application receiving the second consent via an HMI device. The mobile application may be an in-vehicle application, such as the in-vehicle application 121 of the vehicle electronics 100 described above, or a handheld mobile device application, such as the handheld mobile device application 42 of the handheld mobile device 40 described above. The second consent data may be sent from the mobile application to the enrollment module 228 in a variety of ways, including via the OEM gateway 22, the communications subsystem 104, and/or the remote data repository 20. In one embodiment, the second consent data may include data uniquely specifying the vehicle for which the second consent was received. This vehicle identification data that uniquely specifies the vehicle for which the second consent was received may be a vehicle identification number (VIN) or another vehicle identifier usable to uniquely identify the vehicle from the vehicles 14. The method 300 continues to step 330.

In step 330, the vehicle for which the second consent was received is enrolled in a data stream service in which the second data stream is provided from the vehicle to the remote data repository. In at least one embodiment, this step is carried out by the enrollment module 228 of the data product system 12. This step may include storing the second consent data at the data product system 12 or otherwise storing an indication that the vehicle is to be configured to transmit the second data stream. In one embodiment, this includes associating the vehicle with the data stream service, such as by adding the vehicle identification data to a list of vehicles that are enrolled in the data stream service. The method 300 continues to step 340.

In step 340, a streaming data change request to a second subset of the multitude of vehicles is initiated. The streaming data change request specifies the one or more data items used to generate the second data product. In one embodiment, the second request handler 224 receives an indication from the enrollment module 228 indicating that the second consent data has been stored or received, or otherwise indicating that the second consent has been received. In response, the first request handler 224 generates one or more messages that are then sent by the communications handler 226, which cause the streaming data change request to be sent to the communications subsystem 104 of the vehicle electronics 100. For example, the first request handler 224 may generate a streaming data change proposal that is sent from the communications handler 226 to the OEM gateway 22, which then, upon processing the streaming data change proposal, sends a streaming data change request to the communications subsystem 104 of the vehicle electronics 100. According to embodiments, the second subset of vehicles may be a single vehicle or may be a plurality of vehicles. The method 300 continues to step 350.

In at least some embodiments, a method of transmitting a data stream to a remote data repository in response to receiving consent to transmit the data stream may be carried out by each of the second subset of vehicles, such as the method 400 (FIG. 5) described below. Step 440 of the method 400 may be initiated in response to receiving the streaming data change request at the vehicle. The method 400 may be carried out prior to step 350.

In step 350, the second data product is generated using second repository data that is received from the remote data repository. The second repository data includes, or is at least in part based on, the one or more other data items once the one or more other data items begin to be received by the remote data repository. This step may be carried out in the same or a similar manner as step 310, except that second repository data is used to generate the second data product. The method 300 continues to step 360.

In step 360, the first data product and the second data product are provided to at least one third party computing device (e.g., a third party's server, data repository, client device, or portable connected device). In one embodiment, the first data product and second data product are provided to the same third party computing device, such as for purposes of providing both data products to a single customer. In another embodiment, the first data product may be sent or otherwise provided to a first third party computing device associated with a first data product customer, and the second data product may be sent or otherwise provided to a second third party computing device associated with a second data product customer that is different than the first data product customer. In one embodiment, the data product system 12 transmit the data products to the third party computing device or, in another embodiment, the data product system 12 provides a download link to the third party computing device that is usable to access and download the data products. The method 300 then ends.

With reference to FIG. 5, there is shown an embodiment of a method 400 of transmitting a data stream to a remote data repository in response to receiving consent to transmit the data stream. The method 400 is carried out by each of the second subset of vehicles and, in particular and at least according to some embodiments, by the communications subsystem 104 of each of the second subset of vehicles. As mentioned above, the method 400 may be carried out in conjunction with the method 300 (FIG. 4) and, in particular, step 440 may be carried out in response to receiving the streaming data change request.

The method 400 begins with step 410, wherein first data stream is generated and transmitted to a remote data repository. The first data stream comprises data accessed from the vehicle subsystems. The data selection unit 212 may be used to indicate which data items to include as a part of the first data stream. For example, in one embodiment, a first data model indicating one or more data items to be included in the first data stream may be provided by the data selection unit 212. The communications subsystem 104, such as through use of the onboard computer 106, may then obtain the data items from one or more of the plurality of vehicle subsystems 102 and transmit the obtained data items to the remote data repository 20. The method 400 continues to step 420.

In step 420, a second consent is received from a user. In the present embodiment, the second consent is received at the vehicle electronics; however, in other embodiments, the second consent may be received at the handheld mobile device 40 and, in such embodiments, the vehicle electronics or vehicle may not carry out steps 420 and/or 430, but, rather, these steps may be carried out by the handheld mobile device 40. In at least some embodiments, the second consent is received at a mobile application, which may be an in-vehicle application, such as the in-vehicle application 121 of the vehicle electronics 100 described above, or a handheld mobile device application, such as the handheld mobile device application 42 of the handheld mobile device 40 described above. The mobile application may then record into memory the second consent data, which is data that indicates that the second consent has been received. In one embodiment, the mobile application presents a graphical user interface (GUI) to the user of the mobile application that includes information pertaining to the second data stream, such as information pertaining to one or more data items included (or to be included) in the second data stream. For example, the information pertaining to one or more data items that may be presented by the GUI may include a list of the data sources of the data items, data source types of the data items, and/or the data items themselves. In one embodiment, such as when the mobile application is the handheld mobile device application 42, the mobile application may indicate which vehicle the mobile application is seeking consent for. The method 400 continues to step 430.

In step 430, second consent data is sent to the data product system. As mentioned above, the second consent data indicates that a second consent to transmit a second data stream has been received. In one embodiment, the mobile application, which in the present embodiment is the in-vehicle application 121, generates the second consent data. The second consent data is then sent by the wireless communications device 108 of the communications subsystem 104 to the data product system 12. In one embodiment, the second consent data is sent by the wireless communications device 108 of the communications subsystem 104 to the data product system 12 directly and without having to first be sent to the OEM gateway 22 or other computer system managed by the OEM. The method 400 continues to step 440.

In step 440, a streaming data change request is received. The streaming data change request specifies the one or more data items used to generate the second data product. The streaming data change request may be received at the first request handler 210, which may then provide certain information, such as data indicating the one or more data items of the second data stream, surplus data, or a second data model, to the data selection unit 212. In one embodiment, for example, the streaming data change request indicates the second data model, which informs the vehicle electronics that the second data stream is to include the data item(s) indicated by the second data model. In some embodiments, the streaming data change request may, when received at the communications subsystem 104, cause the first data stream to be modified into a second data stream that excludes identified surplus data contained in the first data stream and includes one or more other data items that are not contained in the first data stream, and this is discussed below with respect to the method 600 (FIG. 7). After the streaming data change request is received, the method 400 continues to step 450.

In step 450, the second data stream is transmitted to the remote data repository. The communications subsystem 104 may generate the second data stream based on information indicated by the streaming data change request, and then may transmit the second data stream to the remote data repository 20, at least according to some embodiments. In some embodiments, the second data stream, which includes at least one data item that is/was not contained in the first data stream, is transmitted instead of the first data stream. However, in other embodiments, the first data stream may still be transmitted and the second data stream may be transmitted in addition to the first data stream. The method 400 then ends.

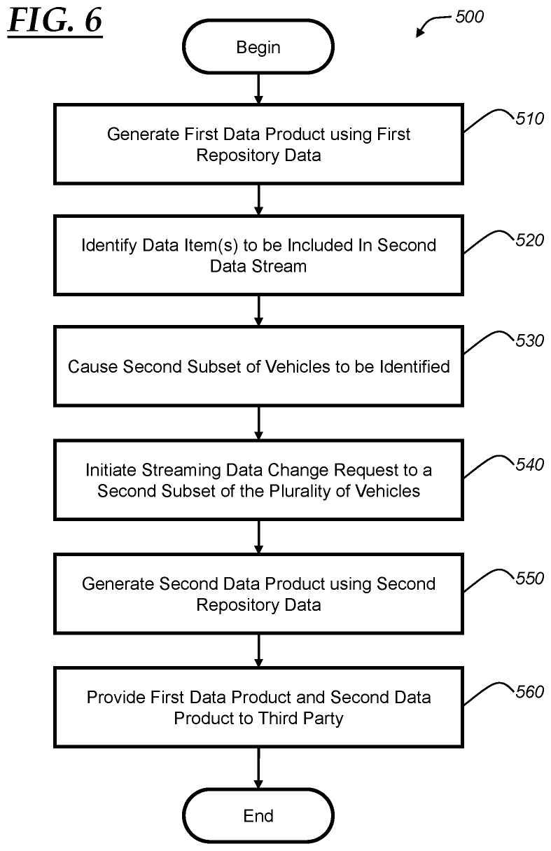

With reference to FIG. 6, there is shown an embodiment of a method 500 of generating and providing a data product using data supplied by a multitude of vehicles. According to at least some embodiments, the method 500 is carried out by the data product system 12 and, in particular, the data product system 12 includes one or more electronic processors (including the electronic processor 36) that are configured to execute computer instructions that, when executed by the one or more electronic processors, cause the data product system 12 to carry out the method 500. Although the steps of the method 500 are described as being carried out in a particular order, it should be appreciated that the steps of the method 500 may be carried out in any technically-feasible order.

The method 500 begins with step 510, wherein a first data product is generated using first repository data that is received from the remote data repository. This step may be carried out in the same or a similar manner as step 310 of the method 300. The method 500 continues to step 520.

In step 520, one or more data items that are to be included in the second data stream are identified. In one embodiment, this step includes determining one or more other data items that are absent from the first data stream and needed to generate a second data product. In at least some embodiments, the second data product includes data derived or otherwise obtained from at least one data item that is not included or used to generate the first data product. In one embodiment, the second request handler 224 of the data product system 12 may receive data product request data that indicates one or more data items needed to generate the second data product. As discussed above, the data product request data may be received directly from the data product customer 200, such as through use of an API, or may be entered into or otherwise provided to the data product system 12 by a person at the direction or request of the data product customer 200.

In addition, in some embodiments, surplus data is identified, wherein the surplus data may comprise one or more data items contained in the first data stream for which the first data product can be generated using the first data stream from a first subset of the multitude of vehicles. In one embodiment, the data product system 12 obtains information concerning a first data set, which is data stored in the remote data repository 20 as a result of the first data stream from the multitude of vehicles 14. This information, which describes the first data set and may be referred to as first data set information, may include portions of the first data set or access information concerning the first data set. The access information refers to information indicating whether certain data of the first data set has been accessed after it has been initially stored at the remote data repository 20. For example, the remote data repository 20 may keep an ongoing access log that logs when and what data is accessed.

In another embodiment, the identification of surplus data may be made without having to access data of the first data set, but, instead, based on whether the system predicts or anticipates that certain data being streamed to the remote data repository 20 is not or will not be needed. For example, the data product system 12 may be configured to determine that there is or will be surplus data stored at the remote data repository 20 if the first data stream continues unmodified based on, for example, the fact that a particular geographical region includes (or is predicted to include at a particular time) a high density of vehicles that are reporting traffic-related information. In such a scenario and in some embodiments, the data product system 12 may be configured to determine that data being streamed, or that will be streamed (if the first data stream is left unmodified), to the remote data repository 20 includes surplus data simply because historically this has been true under these above-described circumstances. The method 500 continues to step 530.

In step 530, the data product system causes a second subset of the multitude of vehicles (referred to as a second subset of vehicles) to be identified based on second consent data. As a part of identifying the second subset of vehicles, the data product system 12 may first identify a consenting subset of vehicles, which are those vehicles of the multitude of vehicles for which second consent data was received by the data product system 12. After identifying the consenting subset of vehicles, the data product system 12 may provide data representing the consenting subset of vehicles to the OEM gateway 22, which may then select one or more vehicles to be included in the second subset of vehicles. In such an embodiment, the data product system 12 may also provide the OEM gateway 22 with vehicle selection parameters. In another embodiment, the data product system 12 may identify the second subset of vehicles by selecting one or more vehicles to be included in the second subset of vehicles based on whether second consent data was received for a given vehicle. Data representing the second subset of vehicles may then be provided to the OEM gateway 22, at least in some embodiments. In some embodiments, the consenting subset of vehicles or the second subset of vehicles may be provided to the OEM gateway 22 (or otherwise sent from the data product system 12) along with a streaming data change request or streaming data change proposal. The method 500 continues to step 540.

In step 540, a streaming data change request to a second subset of the multitude of vehicles is initiated. The streaming data change request specifies the one or more data items of the second data stream. In at least one embodiment, this step is performed by the communications handler 226 of the data product system 12. In some embodiments, this step is performed by sending a streaming data change proposal to the OEM gateway 22 and, in such embodiments, the streaming data change proposal may specify the one or more data items needed to generate the second data product and, in some embodiments, the surplus data. Also, in at least some embodiments, the OEM gateway 22 may be configured so that, when the streaming data change proposal is received, the OEM gateway 22 determines whether to accept the proposal and, if so, generates and transmits a streaming data change request to the second subset of vehicles. In another embodiment, the communications handler 226 (or other portion of the data product system 12) generates and sends the streaming data change request to the second subset of vehicles without having to first send the streaming data change proposal (or other related information) to the OEM gateway 22. The method 500 then continues to step 550.

In at least some embodiments, a method of modifying a data stream and sending the data stream, as modified, to a remote data repository may be carried out by each of the second subset of vehicles, such as the method 600 (FIG. 7) described below. Step 620 of the method 600 may be initiated in response to receiving the streaming data change request at the vehicle. The method 600 may be carried out prior to step 550.

In step 550, the second data product is generated using second repository data that is received from the remote data repository. This step may be carried out in the same or a similar manner as step 310, except that second repository data is used to generate the second data product. The method 500 continues to step 560.

In step 560, the first data product and the second data product are provided to at least one third party computing device (e.g., a third party's server, data repository, client device, or portable connected device). In one embodiment, the first data product and second data product are provided to the same third party computing device, such as for purposes of providing both data products to a single customer. In another embodiment, the first data product may be sent or otherwise provided to a first third party computing device associated with a first data product customer, and the second data product may be sent or otherwise provided to a second third party computing device associated with a second data product customer that is different than the first data product customer. In one embodiment, the data product system 12 transmits the data products to the third party computing device or, in another embodiment, the data product system 12 provides a download link to the third party computing device that is usable to access and download the data products. The method 500 then ends.

With reference to FIG. 7, there is shown an embodiment of a method 600 of modifying a data stream and sending the data stream, as modified, to a remote data repository. The method 600 is carried out by each of the second subset of vehicles and, in particular and at least according to some embodiments, by the communications subsystem 104 of each of the second subset of vehicles. As mentioned above, the method 600 may be carried out in conjunction with the method 500 (FIG. 6) and, in particular, step 620 may be carried out in response to receiving the streaming data change request.

The method 600 begins with step 610, wherein first data stream is generated and transmitted to a remote data repository. This step may be carried out in the same or a similar manner as step 410 of the method 400 (FIG. 5). The method 600 continues to step 620.

In step 620, the first data stream is modified into a second data stream that excludes identified surplus data contained in the first data stream and includes one or more other data items that are not contained in the first data stream. As mentioned above, this step may be carried out in response to receiving a streaming data change request, such as the streaming data change request described above in the method 500 (FIG. 6). The streaming data change request may be received at the first request handler 210, which may then provide certain information, such as data indicating the one or more other data items, surplus data, or a second data model, to the data selection unit 212. In one embodiment, modifying the first data stream into a second data stream includes storing a second data model at the data selection unit 212. The method 600 then continues to step 630.

In step 630, the second data stream is transmitted to the remote data repository in place of the first data stream. After the first data stream is modified into the second data stream, the communications subsystem 104 may then begin to generate the second data stream and then transmit the second data stream to the remote data repository 20, at least according to some embodiments. The second data stream, which includes the other data items that are/were not contained in the first data stream, is transmitted instead of the first data stream. The method 600 then ends.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A data product system for generating and providing a data product using data supplied by a multitude of vehicles, each vehicle having vehicle electronics comprising:
a plurality of vehicle subsystems each providing data; and
a communications subsystem having a wireless communications device and being connected within the vehicle electronics such that the data from the vehicle subsystems is accessible by the communications subsystem, wherein the communications subsystem is configured to:
transmit a first data stream comprising data accessed from the vehicle subsystems, wherein the first data stream is transmitted subsequent to a first consent having been received;
receive a streaming data change request, wherein the streaming data change request is sent in response to a determination that a second consent to transmit a second data stream has been received, wherein the second data stream is different from the first data stream in that the second data stream includes at least one data item not included in the first data stream, and wherein the second consent is received from a vehicle user through use of a mobile application; and
in response to receiving the streaming data change request, transmit the second data stream to the remote data repository;
wherein the data product system is remote from the multitude of vehicles and comprises one or more electronic processors and memory storing computer instructions and wherein the data product system is configured so that, when the computer instructions are executed by the one or more electronic processors, the data product system:
generates a first data product using first repository data that is received from the remote data repository and that includes, or is at least in part based on, at least one data item that is contained in the first data streams received from at least some of the multitude of vehicles;
receives second consent data indicating that a vehicle user has provided the second consent;
generates the second data product using second repository data that is received from the remote data repository and that includes, or is at least in part based on, one or more data items of the second data stream as stored in the remote data repository once the one or more data items begin to be received by the remote data repository; and
provides the first data product to at least one third party computing device and provides the second data product to the same and/or another third party computing device.

2. The data product system of 1, wherein the data product system is configured so that, when the computer instructions are executed by the one or more electronic processors, the data product system:
in response to receiving the second consent data, enrolls the vehicle into a data stream service in which the second data stream is provided from the vehicle to the remote data repository; and
after enrolling the vehicle into the data stream service, causes a streaming data change request to be sent to the communications subsystem.

3. The data product system of claim 2, wherein the streaming data change request indicates the one or more data items to be included in the second data stream.

4. The data product system of claim 3, wherein the communications subsystem is configured to, in response to receiving the streaming data change request, configure the communications subsystem to obtain the one or more data items based on the data provided by the plurality of vehicle subsystems.

5. The data product system of claim 1, wherein the mobile application is an in-vehicle application that is downloadable to and executable by the vehicle.

6. The data product system of claim 5, wherein the communications subsystem is configured to, in response to receiving the second consent from the vehicle user via the in-vehicle application, transmit the second consent data to the data product system.

7. The data product system of claim 1, wherein the mobile application is configured to be executed by a handheld mobile device.

8. The data product system of claim 1, wherein the first data stream is a data stream that is streamed from each of the multitude of vehicles as a result of a standard original equipment manufacturer (OEM) remote data streaming configuration.

9. The data product system of claim 1, wherein the streaming data change request is transmitted from the data product system to an original equipment manufacturer (OEM) gateway and then from the OEM gateway to the communications subsystem.

10. A method of generating and providing a data product using data supplied by a multitude of vehicles, comprising:
generating a first data product using first repository data that is received from a remote data repository and that includes, or is at least in part based on, at least one data item that is contained in a first data stream received from at least some of the multitude of vehicles;
receiving second consent data indicating that a vehicle user has provided a second consent, wherein the multitude of vehicles are configured to transmit the second data stream to the remote data repository in response to receiving a streaming data change request, wherein the streaming data change request is sent in response to a determination that the second consent to transmit a second data stream has been received, wherein the second data stream is different from the first data stream in that the second data stream includes at least one data item not included in the first data stream, and wherein the second consent is received from a vehicle user through use of a mobile application; and
generating a second data product using second repository data that is received from the remote data repository and that includes, or is at least in part based on, one or more data items of a second data stream as stored in the remote data repository once the one or more data items begin to be received by the remote data repository; and
providing the first data product to at least one third party computing device and providing the second data product to the same and/or another third party computing device.

11. The method of claim 10, wherein the method is carried out by a data product system that is remote from the multitude of vehicles and comprises one or more electronic processors and memory storing computer instructions, and wherein the data product system is configured so that, when the computer instructions are executed by the one or more electronic processors, the data product system carries out the method.

12. The method of claim 10, wherein each of the multitude of vehicles is a vehicle having vehicle electronics including: a plurality of vehicle subsystems each providing data; and a communications subsystem having a wireless communications device and being connected within the vehicle electronics such that the data from the vehicle subsystems is accessible by the communications subsystem, wherein the communications subsystem is configured to: transmit the first data stream comprising data accessed from the vehicle subsystems, wherein the first data stream is only transmitted provided the first consent has been received; receive the streaming data change request; and in response to receiving the streaming data change request, transmit the second data stream to the remote data repository.

13. The method of claim 10, wherein the data product system is configured so that, when the computer instructions are executed by the one or more electronic processors, the data product system:
in response to receiving the second consent data, enrolls the vehicle into a data stream service in which the second data stream is provided from the vehicle to the remote data repository; and
after enrolling the vehicle into the data stream service, causes a streaming data change request to be sent to the communications subsystem.

14. The method of claim 13, wherein the streaming data change request indicates the one or more data items to be included in the second data stream.

15. The method of claim 14, wherein the communications subsystem is configured to, in response to receiving the streaming data change request, configure the communications subsystem to obtain the one or more data items based on the data provided by the plurality of vehicle subsystems.

16. The method of claim 9, wherein the mobile application is an in-vehicle application that is downloadable to and executable by the vehicle.

17. The method of claim 16, wherein the communications subsystem is configured to, in response to receiving the second consent from the vehicle user via the in-vehicle application, transmit the second consent data to the data product system.

18. The method of claim 9, wherein the mobile application is configured to be executed by a handheld mobile device.

19. The method of claim 9, wherein the first data stream is a data stream that is streamed from each of the multitude of vehicles as a result of a standard original equipment manufacturer (OEM) remote data streaming configuration.

20. The method of claim 9, wherein the streaming data change request is transmitted from the data product system to an original equipment manufacturer (OEM) gateway and then from the OEM gateway to the communications subsystem.
